(19) United States
(12) Patent Application Publication
(10) Pub. No.: US 2026/0304534 A1
(43) Pub. Date: Oct. 1, 2026

(54) Network and method of handling collision of a UE-requested PDU session modification procedure and a network-requested PDU session modification procedure

(71) Applicant: MEDIATEK INC., Hsin-Chu (TW)

(72) Inventors: Yuan-Chieh Lin, Hsinchu City (TW); Yu-Hsin Lin, Hsinchu City (TW)

(73) Assignee: MEDIATEK INC., Hsin-Chu (TW)

(21) Appl. No.: 19/474,729

(22) PCT Filed: May 17, 2024
(86) PCT No.: PCT/CN2024/093982

§ 371 Date: Oct. 13, 2025

Related U.S. Application Data
(60) Provisional application No. 63/503,178, filed on May 19, 2023.

(51) Int. Cl. H04W 76/20; H04W 40/02

(52) U.S. Cl. CPC H04W 76/20; H04W 40/02

(57) ABSTRACT

A network and a method of handling collision of a UE-requested PDU session modification procedure and a network-requested PDU session modification procedure are provided. When the collision occurs, and connection capabilities are included in a PDU SESSION MODIFICATION REQUEST message received from a user equipment (UE), the network determines that the UE has the capability to support the URSP rule enforcement according to the connection capabilities included in the PDU SESSION MODIFICATION REQUEST message, and the UE-requested PDU session modification procedure initiated by PDU SESSION MODIFICATION REQUEST message will not proceed.

### CROSS REFERENCE TO RELATED APPLICATION

This application claims the benefit of U.S. Provisional Application No. 63/503,178, filed on May 19, 2023. The content of the application is incorporated herein by reference.

### TECHNICAL FIELD

The disclosed embodiments relate generally to wireless communication, and, more particularly, to networks and methods for handling collision of a UE-requested protocol data unit (PDU) session modification procedure and a network-requested PDU session modification procedure.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the realm of 5th generation wireless systems (5G) technology, PDU (Protocol Data Unit) sessions play a crucial role in enabling seamless data transmission between user devices and networks, such as the internet. These PDU sessions act as dedicated pathways, ensuring the efficient and reliable delivery of application data packet.

In 5G, the PDU Session Modification procedure enables both the user equipment (UE) and the network to modify the parameters of an existing PDU session. However, scenarios can arise where the UE and the network simultaneously initiate PDU session modification requests for the same PDU session. This situation is referred to as a collision between the UE-requested and network-requested PDU session modification procedures. Collision scenarios in 5G PDU session modification are handled by prioritizing requests and applying the prioritized modifications. The non-prioritized request is either rejected or aborted, depending on its origin (UE or network). This structured approach ensures that both UE and network modifications are handled efficiently and in a controlled manner.

In the context of 5G networks defined by 3GPP specifications, the UE Route Selection Policy (URSP) plays a crucial role in enabling efficient and flexible traffic management. URSP is a mechanism that allows the network to dynamically assign traffic flows from User Equipments (UEs) to appropriate network slices based on specific criteria. This dynamic routing capability is essential for supporting diverse network slicing scenarios and ensuring optimal resource utilization in 5G networks.

### SUMMARY

In an embodiment of the present disclosure, a method of handling collision of a UE-requested protocol data unit (PDU) session modification procedure and a network-requested PDU session modification procedure is disclosed. The method comprises the network determining whether a PDU session indicated in the PDU SESSION MODIFICATION REQUEST message matches a PDU session associated with the network-requested PDU session modification procedure when a network receives a PDU SESSION MODIFICATION REQUEST message from a user equipment (UE) during the network-requested PDU session modification procedure; if the PDU session indicated in the PDU SESSION MODIFICATION REQUEST message matches the PDU session associated with the network-requested PDU session modification procedure, the network determining that the collision has occurred and determining whether the PDU SESSION MODIFICATION REQUEST message includes connection capabilities; and if the collision has occurred and the PDU SESSION MODIFICATION REQUEST message includes the connection capabilities, the network ignoring the PDU SESSION MODIFICATION REQUEST message except for the connection capabilities and proceeding with the network-requested PDU session modification procedure.

In another embodiment of the present disclosure, a method of handling collision between a network and a user equipment (UE) is disclosed. The method comprises during a network-requested PDU session modification procedure, when the network receives a request message from the UE requesting a UE-requested protocol data unit (PDU) session modification procedure, the network determining whether a PDU session indicated in the request message matches a PDU session associated with the network-requested PDU session modification procedure; if the PDU session indicated in the request message matches the PDU session associated with the network-requested PDU session modification procedure, the network determining that the collision has occurred and determining whether the request message includes connection capabilities; and if the collision has occurred and the request message includes the connection capabilities, the network ignoring the request message except for the connection capabilities and proceeding with the network-requested PDU session modification procedure.

In another embodiment of the present disclosure, a network is disclosed. The network comprises a session management function (SMF), an access and mobility management function (AMF), a user plane function (UPF), and a policy control function (PCF). The SMF is configured to exchange signaling messages with a user equipment (UE). The AMF is configured to forward session management related signaling messages between the SMF and the UE. The UPF is configured to perform establishing, modifying, and releasing protocol data unit (PDU) sessions between the network and the UE. The PCF is configured to disseminate UE Route Selection Policy (URSP) to the UE and the AMF. When the network receives a PDU SESSION MODIFICATION REQUEST message from the UE requesting a UE-requested PDU session modification procedure during a network-requested PDU session modification procedure, the SMF determines whether a PDU session indicated in the PDU SESSION MODIFICATION REQUEST message matches a PDU session associated with the network-requested PDU session modification procedure. If the PDU session indicated in the PDU SESSION MODIFICATION REQUEST message matches the PDU session associated with the network-requested PDU session modification procedure, the SMF determines that a collision has occurred and determines whether the PDU SESSION MODIFICATION REQUEST message includes connection capabilities. If the collision has occurred and the PDU SESSION MODIFICATION REQUEST message includes the connection capabilities, the SMF ignores the PDU SESSION MODIFICATION REQUEST message except for the connection capabilities and proceeds with the network-requested PDU session modification procedure.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a communication system according to an embodiment of the disclosure.

FIG. 2 shows an example of the PDU session according to an embodiment of the disclosure.

FIG. 3 shows an example of a UE-requested PDU session establishment procedure.

FIG. 4 shows an example procedure of the communication system for handling a network-requested PDU session modification procedure initiated by the SMF of the network.

FIG. 5 shows an example procedure of the communication system for handling a UE-requested PDU session modification procedure initiated by the UE.

FIG. 6 shows an example collision between the UE and the SMF of the network.

FIG. 7 shows a procedure for handling the collision of the UE-requested PDU session modification procedure and the network-requested PDU session modification procedure.

### DETAILED DESCRIPTION

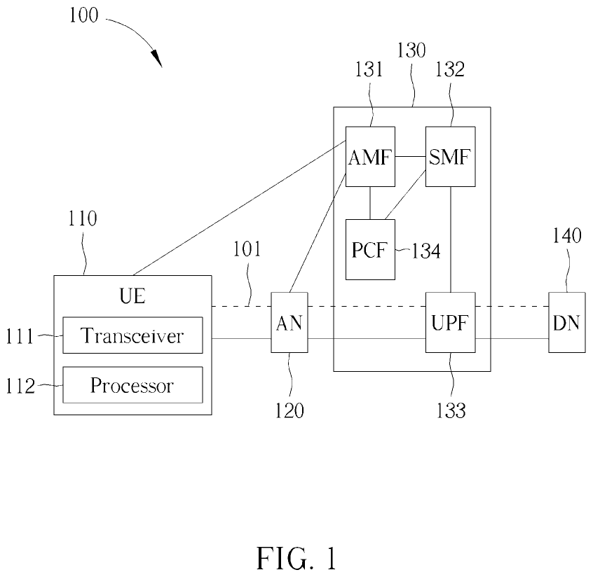

FIG. 1 shows a communication system 100 according to an embodiment of the disclosure. The communication system 100 can be a fifth generation system (5GS) that includes a user equipment (UE) 110, an access network (AN) 120, a network 130, and a data network (DN) 140. The network 130 can be a fifth generation core (5GC) network, and it may support various network functions, including an access and mobility management function (AMF) 131, a session management function (SMF) 132, a user plane function (UPF) 133, and a policy control function (PCF) 134. Each network function may be implemented as a network element on dedicated hardware, or as a software instance running on dedicated hardware, or as a virtualized function instantiated on an appropriate platform, e.g., a cloud infrastructure. The AMF 131, the SMF 132, the UPF 133, and the PCF 134 are coupled with each other and can coordinate with each other to establish, modify, or release a protocol data unit (PDU) session 101 for exchanging data units (e.g., IP packets, Ethernet data frames, unstructured data, and the like) between the UE 110 and the DN 140.

The UE 110 can be a mobile phone, a laptop, a vehicle, and the like. The AN 120 can be a 3rd Generation Partnership Project (3GPP) radio network (e.g., a gNB as specified in 3GPP New Radio standards), or a non-3GPP network (e.g., a Wi-Fi, WiMAX, or fixed network). The UE 110 comprises a transceiver 111 and a processor 112. The transceiver 111 may include one or more antennas, and is used to wirelessly receive signals from the network 130 and transmit signals to the network 130. The processor 112 is coupled to the transceiver 111 and used to process the signals received by the transceiver 111. The processor 112 invokes different functional modules and circuits to perform features in the UE 110. The network 130 is specified in 3GPP 5G standards. The AMF 131 can be configured to forward session management related signaling messages between the SMF 132 and the UE 110. The SMF 132 is configured to exchange signaling messages with the UE 110, the AN 120, and the UPF 133 to perform session management functions, such as establishment, modification, and release of the PDU session 101. The PCF 134 serves as the policy enforcer, applying policies and rules to control network behavior. The PCF 134 can disseminate the UE Route Selection Policy (URSP) to the UE 110 and the AMF 131.

If the UE 110 has capability of support the URSP rule enforcement, the PCF 134 may indicate the UE 110 to send reporting of the URSP rule enforcement. If the PCF 134 indicates to the UE 110 to send reporting of the URSP rule enforcement, and if a UE URSP rule includes the connection capabilities in the traffic descriptor (TD), when the UE 110 associates a newly detected application to an existing PDU Session based on URSP evaluation result, the UE 110 shall send a PDU SESSION MODIFICATION REQUEST message including the connection capabilities contained in the TD of the associated URSP rule. The connection capabilities are defined in UE Route Selection Policy (URSP) rule enforcement, and may include QoS parameters (e.g., data rate, latency, and packet loss rate), security information (e.g., encryption algorithms and authentication methods), and additional Information (e.g., network load, congestion levels, and service availability).

In operation, 5GS session management (5GSM) processes can be performed over a non-access stratum (NAS) signaling connection between the UE 110 and the AMF 131 for PDU connection handling in the UE 110 and in the SMF 132. For example, a 5GS mobility management (5GMM) protocol can operate between the UE 110 and the AMF 131, and be used as a transport protocol. A 5GSM message of a 5GSM protocol can be piggybacked in a 5GMM transport message. For example, the 5GSM message can be transmitted in an information element (IE) in the 5GMM transport message. The 5GSM procedures can include a UE-requested PDU session establishment procedure, a PDU session modification procedure, and a PDU session release procedure.

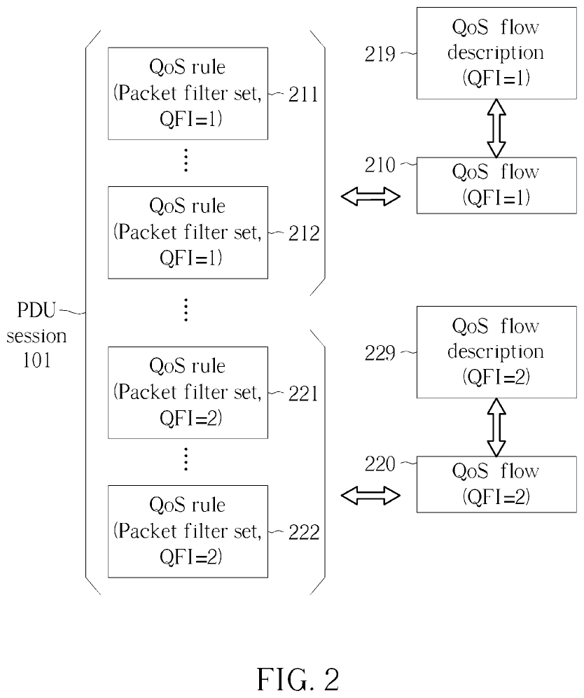

FIG. 2 shows an example of the PDU session 101 according to an embodiment of the disclosure. The PDU session 101 can be of a PDU session type of IPV4, IPv6, IPv4v6, Ethernet, or the like. The PDU session 101 can include one or more quality of service (QOS) flows 210 to 220. Each of the QoS flows 210 to 220 has a QoS flow identifier (QFI) and is associated with one or more QoS rules, and may further be associated with a QoS flow description. For example, the QoS flow 210 of QFI=1 is associated with QoS rules 211 to 212, and may further be associated with a QoS flow description 219. The QoS flow 220 of QFI=2 is associated with QoS rules 221 to 222, and may further be associated with a QoS flow description 229. The QoS rules 211 to 212 and 221 to 222 and the QoS flow descriptions 219 to 229 are crucial as they determine how different types of data are treated within the communication system 100, ensuring that each data packet gets the appropriate level of service.

The QoS rules of the PDU session 101 can be signaled from the network 130 when the PDU session 101 is established or modified, or they can be derived locally using a reflective QoS scheme. Each signaled QoS rule, such as the QoS rules 211 to 212 and 221 to 222, can include several components. These components include an indication of whether the QoS rule is a default QoS rule, a QoS rule identifier (QRI), and a QoS Flow Identifier (QFI) corresponding to the associated QoS flow. Additionally, each signaled QoS rule may further include a set of packet filters (a packet filter set), and a precedence value. The packet filter set can include zero or more packet filters (other than a match-all packet filter) for uplink or downlink. These packet filters are used to classify data units into the respective QoS flows. A default QoS rule may include a match-all packet filter, and typically be assigned with the lowest precedence. During a filtering operation, the filter sets are used according to the precedence of the respective QoS rules. Packets not matching other packet filters can be collected into the QoS flow, referred to as a default QoS flow, associated with the default QoS rule.

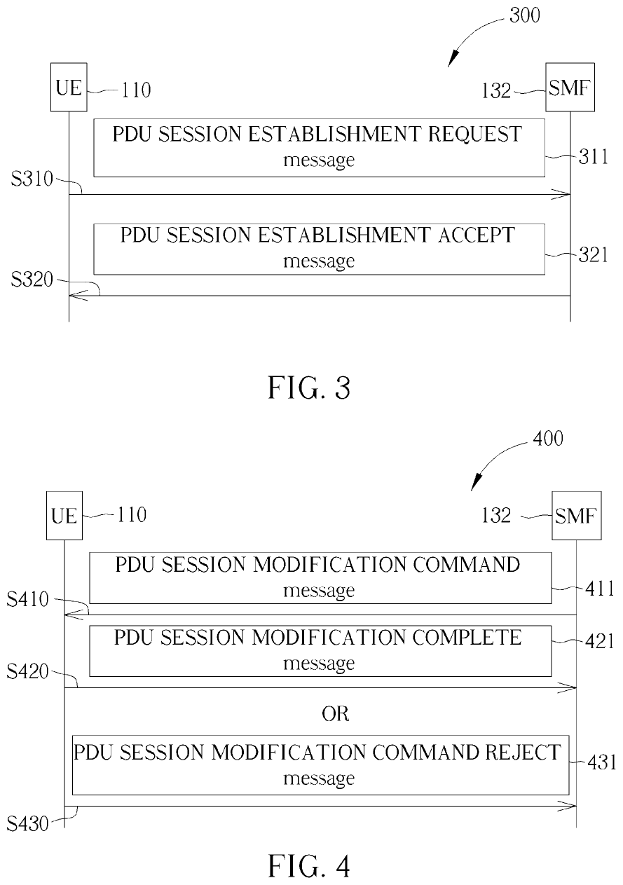

FIG. 3 shows an example of a UE-requested PDU session establishment procedure 300. The UE-requested PDU session establishment procedure 300 can include steps S310 to S320, and be performed between the UE 110 and the SMF 132 to establish a target PDU session.

At step S310, a PDU SESSION ESTABLISHMENT REQUEST message 311 can be transmitted from the UE 110 to the SMF 132. The PDU SESSION ESTABLISHMENT REQUEST message 311 may include an associated PDU session ID, a PDU session type information element (IE), a session and service continuity (SSC) mode IE, a maximum number of packet filters the UE 110 supports, a requested data network name (DNN), and the like.

At step S320, a PDU SESSION ESTABLISHMENT ACCEPT message 321 can be transmitted from the SMF 132 to the UE 110. The PDU SESSION ESTABLISHMENT ACCEPT message 321 can include an authorized QoS rules IE that is set to QoS rules authorized to the target PDU session.

In 5G, the PDU session modification procedure is a critical process that allows the network to adapt to changing conditions and demands. By dynamically adjusting the QoS rules 211 to 212 and 221 to 222 and the QoS flow descriptions 219 to 229, the communication system 100 can prioritize critical data, optimize resource allocation, and maintain overall network performance. This means that the most important data can be transmitted first, resources can be allocated where they are most needed, and the network can continue to function optimally even under changing conditions. By prioritizing critical data, optimizing resource allocation, and adapting to dynamic demands, PDU sessions empower 5G networks to deliver the seamless connectivity and high-performance experience that users crave. The PDU session modification procedure may be requested by the SMF 132 or by the UE 110.

FIG. 4 shows an example procedure 400 of the communication system 100 for handling a network-requested PDU session modification procedure initiated by the SMF 132 of the network 130. The procedure 400 can include steps S410 to S420 (or S430), and be performed by the SMF 132 and the UE 110 to modify an existing PDU session.

At step S410, the SMF 132 of the network 130 sends a PDU SESSION MODIFICATION COMMAND message 411 to the UE 110 to initiate a network-requested PDU session modification procedure. If the network-requested PDU session modification procedure is accepted by the UE 110, step S420 would be executed; otherwise, step S430 would be executed

At step S420, the UE 110 can transmit a PDU SESSION MODIFICATION COMPLETE message 421 to the SMF 132. Or, at step S430, the UE 110 can transmit a PDU SESSION MODIFICATION COMMAND REJECT message 431 with a 5GSM cause IE indicating a reason for rejecting the PDU session modification. For example, the 5GSM cause IE may include a value of #26, insufficient resources; #43, invalid PDU session identity; #44,semantic error in packet filter(s); #45, syntactical error in packet filter(s); #83, semantic error in the QoS operation; #84, syntactical error in the QoS operation; or the like.

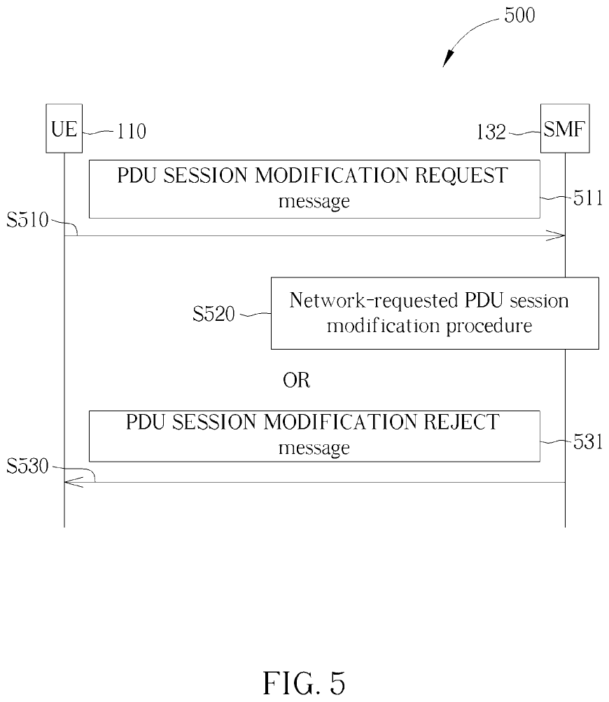

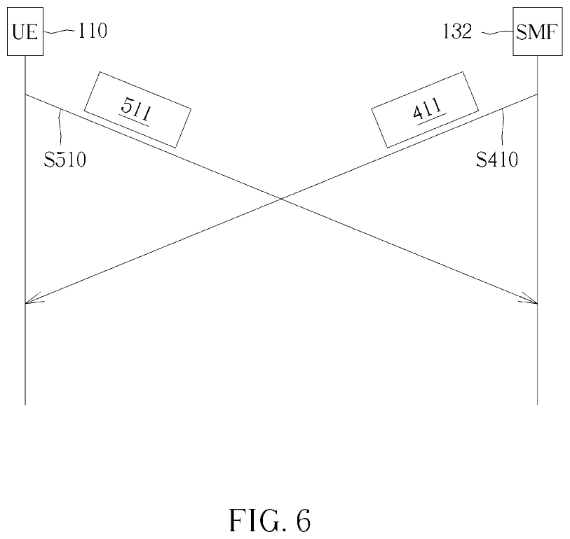

FIG. 5 shows an example procedure 500 of the communication system 100 for handling a UE-requested PDU session modification procedure initiated by the UE 110. The procedure 500 can include steps S510 to S520 (or S530), and be performed by the SMF 132 and the UE 110 to modify an existing PDU session.

At step S510, the UE 110 sends a PDU SESSION MODIFICATION REQUEST message 511 to the SMF 132 to initiate the UE-requested PDU session modification procedure. If the UE-requested PDU session modification procedure is accepted by the SMF 132 of the network 130, step S520 would be executed; otherwise, step S530 would be executed

At step S520, the SMF 132 proceeds with a Network-requested PDU session modification procedure triggered by the accepted UE-requested PDU session modification procedure, and transmits a PDU SESSION MODIFICATION ACCEPT message to the UE 110. At step S530, the SMF 132 can transmit a PDU SESSION MODIFICATION REJECT message 531 with a 5GSM cause IE indicating a reason for rejecting the PDU session modification. For example, the 5GSM cause IE may include a value of #43, Invalid PDU session identity; #95, Protocol Error or Semantically incorrect message; or the like.

FIG. 6 shows an example collision between the UE 110 and the SMF 132 of the network 130. The collision occurs when the SMF 132 sends the PDU SESSION MODIFICATION COMMAND message 411 to the UE 110 to initiate the network-requested PDU session modification procedure while the UE 110 sends the PDU SESSION MODIFICATION REQUEST message 511 to the SMF 132 to initiate the UE-requested PDU session modification procedure, and the PDU session indicated in the PDU SESSION MODIFICATION REQUEST message 511 matches the PDU session associated with the network-requested PDU session modification procedure. In this case, the SMF 132 receives the PDU SESSION MODIFICATION REQUEST message 511 from the UE 110 during the network-requested PDU session modification procedure. In other words, the SMF 132 receives the PDU SESSION MODIFICATION REQUEST message 511 in the state PDU SESSION MODIFICATION PENDING, a state defined in the 3GPP specifications.

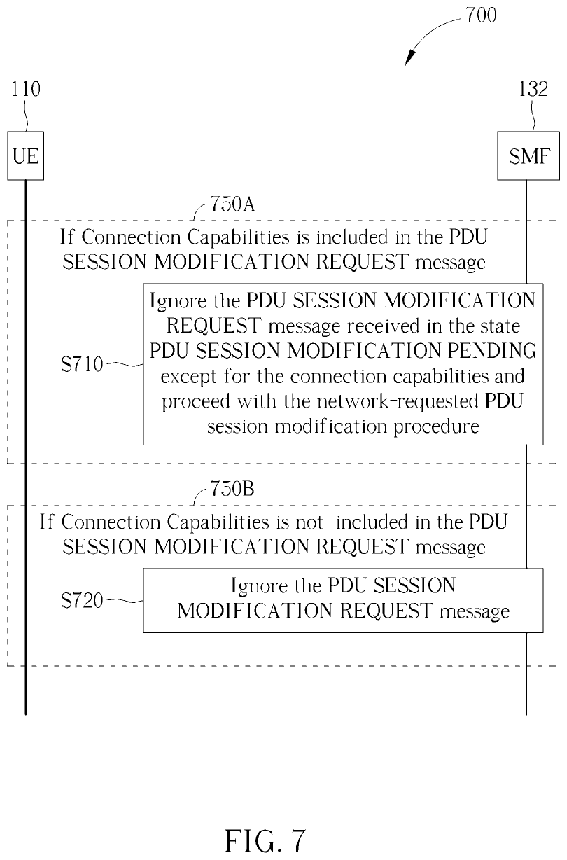

FIG. 7 shows a procedure 700 for handling the collision of the UE-requested PDU session modification procedure and the network-requested PDU session modification procedure. When the network 130 receives the PDU SESSION MODIFICATION REQUEST message 511 from the UE 110 requesting the UE-requested PDU session modification procedure during the network-requested PDU session modification procedure, the SMF 132 determines whether the collision of the UE-requested PDU session modification procedure and the network-requested PDU session modification procedure has occurred by determining whether the PDU session indicated in the PDU SESSION MODIFICATION REQUEST message 511 matches the PDU session associated with the network-requested PDU session modification procedure. If the PDU session indicated in the PDU SESSION MODIFICATION REQUEST message is different from the PDU session associated with the network-requested PDU session modification procedure, the SMF 132 determines that no collision of the network-requested PDU session modification procedure and the UE-requested PDU session modification procedure has occurred, and then the SMF 132 proceeds with the UE-requested PDU session modification procedure and the network-requested PDU session modification procedure. If the PDU session indicated in the PDU SESSION MODIFICATION REQUEST message 511 matches the PDU session associated with the network-requested PDU session modification procedure, the SMF 132 determines that the collision has occurred. When the SMF 132 determines that the collision has occurred, the SMF 132 further determines whether the PDU SESSION MODIFICATION REQUEST message 511 includes the connection capabilities defined in the UE Route Selection Policy (URSP) rule enforcement.

Upon the determination by the SMF 132 whether the PDU SESSION MODIFICATION REQUEST message 511 includes the connection capabilities, the procedure 700 can subsequently be conducted. Corresponding to different scenarios (e.g., scenarios of 750A and 750B), different groups of steps can be conducted in the procedure 700.

In a first scenario of 750A, if it is determined that the collision has occurred and the PDU SESSION MODIFICATION REQUEST message 511 includes the connection capabilities, a step S710 can be performed. At step S710, the SMF 132 ignores the PDU SESSION MODIFICATION REQUEST message 511 except for the connection capabilities and proceeds with the network-requested PDU session modification procedure. Accordingly, the SMF 132 can determine that the UE 110 has the capability to support the URSP rule enforcement according to the connection capabilities included in the PDU SESSION MODIFICATION REQUEST message 511 without proceeding with the UE-requested PDU session modification procedure.

In a second scenario of 750B, if it is determined that the collision has occurred and the PDU SESSION MODIFICATION REQUEST message 511 does not include the connection capabilities, a step S720 can be performed. At step S720, the SMF 132 ignores the entire PDU SESSION MODIFICATION REQUEST message 511 and proceeds with the network-requested PDU session modification procedure. Accordingly, the UE-requested PDU session modification procedure will not proceed.

When the SMF 132 ignores the PDU SESSION MODIFICATION REQUEST message 511, it means that the SMF 132 will neither send the PDU SESSION MODIFICATION REJECT message 531 nor send the PDU SESSION MODIFICATION COMMAND message 411 to the UE 110 after the SMF 132 receives the PDU SESSION MODIFICATION REQUEST message 511.

To sum up, the disclosure provides a network and a method of handling the collision of a UE-requested PDU session modification procedure and a network-requested PDU session modification procedure. When the collision occurs, and the connection capabilities are included in the PDU SESSION MODIFICATION REQUEST message, the network can determine that the UE has the capability to support the URSP rule enforcement according to the connection capabilities included in the PDU SESSION MODIFICATION REQUEST message, and the UE-requested PDU session modification procedure will not proceed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling collision of a UE-requested protocol data unit (PDU) session modification procedure and a network-requested PDU session modification procedure, comprising:
when a network receives a PDU SESSION MODIFICATION REQUEST message from a user equipment (UE) during the network-requested PDU session modification procedure, the network determining whether a PDU session indicated in the PDU SESSION MODIFICATION REQUEST message matches a PDU session associated with the network-requested PDU session modification procedure;
if the PDU session indicated in the PDU SESSION MODIFICATION REQUEST message matches the PDU session associated with the network-requested PDU session modification procedure, the network determining that the collision has occurred and determining whether the PDU SESSION MODIFICATION REQUEST message includes connection capabilities; and
if the collision has occurred and the PDU SESSION MODIFICATION REQUEST message includes the connection capabilities, the network ignoring the PDU SESSION MODIFICATION REQUEST message except for the connection capabilities and proceeding with the network-requested PDU session modification procedure.

2. The method of claim 1, further comprising:
if the collision has occurred and the PDU SESSION MODIFICATION REQUEST message does not include the connection capabilities, the network ignoring the PDU SESSION MODIFICATION REQUEST message and proceeding with the network-requested PDU session modification procedure.

3. The method of claim 1, further comprising:
if the PDU session indicated in the PDU SESSION MODIFICATION REQUEST message is different from the PDU session associated with the network-requested PDU session modification procedure, the network proceeding with the UE-requested PDU session modification procedure and the network-requested PDU session modification procedure.

4. The method of claim 1, further comprising:
the network sending a PDU SESSION MODIFICATION COMMAND message to the UE to initiate the network-requested PDU session modification procedure.

5. The method of claim 1, wherein the UE initiates the UE-requested PDU session modification procedure by sending the PDU SESSION MODIFICATION REQUEST message to the network.

6. The method of claim 1, wherein the connection capabilities are for URSP (UE Route Selection Policy) rule enforcement reporting from the UE to the network.

7. The method of claim 1, wherein the network is a fifth generation core (5GC) network.

8. A method of handling collision between a network and a user equipment (UE), comprising:
during a network-requested PDU session modification procedure, when the network receives a request message from the UE requesting a UE-requested protocol data unit (PDU) session modification procedure, the network determining whether a PDU session indicated in the request message matches a PDU session associated with the network-requested PDU session modification procedure;
if the PDU session indicated in the request message matches the PDU session associated with the network-requested PDU session modification procedure, the network determining that the collision has occurred and determining whether the request message includes connection capabilities; and
if the collision has occurred and the request message includes the connection capabilities, the network ignoring the request message except for the connection capabilities and proceeding with the network-requested PDU session modification procedure.

9. The method of claim 8, further comprising:
if the collision has occurred and the request message does not include the connection capabilities, the network ignoring the request message and proceeding with the network-requested PDU session modification procedure.

10. The method of claim 8, further comprising:
if the PDU session indicated in the request message is different from the PDU session associated with the network-requested PDU session modification procedure, the network proceeding with the UE-requested PDU session modification procedure and the network-requested PDU session modification procedure.

11. The method of claim 8, further comprising:
the network sending a command message to the UE to initiate the network-requested PDU session modification procedure.

12. The method of claim 8, wherein the UE initiates the UE-requested PDU session modification procedure by sending the request message to the network.

13. The method of claim 8, wherein the connection capabilities are defined in UE Route Selection Policy (URSP) rule enforcement.

14. The method of claim 8, wherein the network is a fifth generation core (5GC) network.

15. A network, comprising:
a session management function (SMF), configured to exchange signaling messages with a user equipment (UE);
an access and mobility management function (AMF), configured to forward session management related signaling messages between the SMF and the UE;
a user plane function (UPF), configured to perform establishing, modifying, and releasing protocol data unit (PDU) sessions between the network and the UE; and
a policy control function (PCF), configured to disseminate UE Route Selection Policy (URSP) to the UE and the AMF;
wherein when the network receives a PDU SESSION MODIFICATION REQUEST message from the UE requesting a UE-requested PDU session modification procedure during a network-requested PDU session modification procedure, the SMF determines whether a PDU session indicated in the PDU SESSION MODIFICATION REQUEST message matches a PDU session associated with the network-requested PDU session modification procedure;
wherein if the PDU session indicated in the PDU SESSION MODIFICATION REQUEST message matches the PDU session associated with the network-requested PDU session modification procedure, the SMF determines that a collision has occurred and determines whether the PDU SESSION MODIFICATION REQUEST message includes connection capabilities; and
wherein if the collision has occurred and the PDU SESSION MODIFICATION REQUEST message includes the connection capabilities, the SMF ignores the PDU SESSION MODIFICATION REQUEST message except for the connection capabilities and proceeds with the network-requested PDU session modification procedure.

16. The network of claim 15, wherein if the collision has occurred and the PDU SESSION MODIFICATION REQUEST message does not include the connection capabilities, the SMF ignores the PDU SESSION MODIFICATION REQUEST message and proceeds with the network-requested PDU session modification procedure.

17. The network of claim 15, wherein if the PDU session indicated in the PDU SESSION MODIFICATION REQUEST message is different from the PDU session associated with the network-requested PDU session modification procedure, the SMF proceeds with the UE-requested PDU session modification procedure and the network-requested PDU session modification procedure.

18. The network of claim 15, wherein the network sending a PDU SESSION MODIFICATION COMMAND message to the UE to initiate the network-requested PDU session modification procedure.

19. The network of claim 15, wherein the UE initiates the UE-requested PDU session modification procedure by sending the PDU SESSION MODIFICATION REQUEST message to the network.

20. The network of claim 15, wherein the connection capabilities are defined in the UE Route Selection Policy (URSP) rule enforcement.
